(19) United States
(12) Patent Application Publication
(10) Pub. No.: US 2026/0267589 A1
(43) Pub. Date: Sep. 10, 2026

(54) AUDIO RETURN CHANNEL TRANSMITTER OF HIGH-DEFINITION MULTIMEDIA INTERFACE

(71) Applicant: REALTEK SEMICONDUCTOR CORPORATION, HSINCHU (TW)

(72) Inventors: CHIEN-HSUN LU, HSINCHU (TW); YI-HAN PENG, HSINCHU (TW); CHIA-HAO CHANG, HSINCHU (TW)

(21) Appl. No.: 19/558,870

(22) Filed: Mar. 6, 2026

(30) Foreign Application Priority Data
Mar. 7, 2025 (TW) 114108605

(51) Int. Cl. G06F 3/16; G10L 19/008

(52) U.S. Cl. CPC G06F 3/162; G10L 19/008

(57) ABSTRACT

An audio return channel (ARC) transmitter of a high-definition multimedia interface (HDMI) is configured to output an audio signal and includes a digital transmission interface converter, a buffer circuit, a frame encoder, an ARC analog transmitting end, and a clock tracking circuit. The digital transmission interface converter is configured to convert a first audio packet into multiple audio samples. The buffer circuit is configured to store the audio samples according to a first clock and output the audio samples according to a second clock. The frame encoder is configured to encode the audio samples to generate a second audio packet. The ARC analog transmitting end is configured to generate the second clock and to generate the audio signal according to the second clock and the second audio packet. The clock tracking circuit is configured to adjust the second clock according to the first clock and the second clock.

### BACKGROUND OF THE INVENTION

### 1. Field of the Invention

The present invention generally relates to a High-Definition Multimedia Interface (HDMI), and more particularly, to an Audio Return Channel (ARC) of the HDMI.

### 2. Description of Related Art

The ARC (including, but not limited to, the enhanced Audio Return Channel (eARC), hereinafter collectively referred to as “ARC”) is an important function of the HDMI, which allows the HDMI sink to send the dual-channel audio conforming to the IEC60958-1 specification back to the HDMI source or the HDMI repeater. The conventional ARC transmitter is a device that directly carries the dual-channel audio, which conforms to the IEC60958-1 specification and is reconstructed after being parsed by the HDMI sink at the front end, on the HDMI Ethernet and Audio Return Channel (HEAC) for backward transmission. Such a structure causes significant audio jitter during ARC transmission due to the inherent limitation of HDMI itself in transmitting both video and audio. This limitation is primarily due to the HDMI protocol, which only permits audio transmission during the horizontal blank interval (HBI) or the vertical blank interval (VBI) of the video signal. The discontinuity of the audio packets causes significant clock jitter at the HDMI sink, as it reconstructs the audio packets to output continuous sound, resulting from large frequency variations. This jitter may cause the device to fail the Compatibility Test Suite (CTS) or result in compatibility issues for the ARC receiving end during reception. In order for the HDMI sink to restore the audio packet to continuous audio that conforms to the IEC60958-1 standard, the HDMI sink needs to reconstruct an audio clock.

Reference is made to FIG. 1, which is the schematic diagram of reconstructing an audio clock according to the prior art. The audio samples exhibit a periodic-like fluctuation, with the number of audio samples decreasing in the horizontal active interval H_atv and increasing in the HBI H_blk. In other words, the number of audio samples per unit time decreases gradually in the horizontal active interval H_atv, and increases gradually in the HBI H_blk. During the process of reconstructing the audio clock Clk_aud, the HDMI sink first stores the audio samples into a storage device (e.g., a Static Random Access Memory (SRAM)) and restores the clock according to the number of audio samples received within a unit time. Due to the HDMI sink receiving more audio samples per unit time in the HBI H_blk than in the horizontal active interval H_atv, the HDMI sink generates a relatively high frequency audio clock Clk_aud in the HBI H_blk, and generates a relatively low frequency audio clock Clk_aud in the horizontal active interval H_atv. This obvious clock jitter causes the aforementioned compatibility issues.

### SUMMARY OF THE INVENTION

In view of the issues of the prior art, an object of the present invention is to provide an Audio Return Channel (ARC) transmitter of the HDMI, so as to make an improvement to the prior art.

According to one aspect of the present invention, an Audio Return Channel (ARC) transmitter of a High-Definition Multimedia Interface (HDMI) is provided. The ARC transmitter is configured to output an audio signal and includes a digital transmission interface converter, a buffer circuit, a frame encoder, an ARC analog transmitting end, and a clock tracking circuit. The digital transmission interface converter is configured to convert a first audio packet into multiple audio samples. The buffer circuit is coupled to the digital transmission interface converter and is configured to store the audio samples according to a first clock and to output the audio samples according to a second clock. The frame encoder is coupled to the buffer circuit and is configured to encode the audio samples to generate a second audio packet. The ARC analog transmitting end is coupled to the buffer circuit and the frame encoder and is configured to generate the second clock and to generate the audio signal based on the second clock and the second audio packet. The clock tracking circuit is coupled to the digital transmission interface converter and the ARC analog transmitting end and is configured to adjust the second clock according to the first clock and the second clock.

According to another aspect of the present invention, an ARC transmitter of an HDMI is provided. The ARC transmitter is configured to output an audio signal and includes a digital transmission interface converter, a buffer circuit, a frame encoder, an ARC analog transmitting end, and a clock adjustment circuit. The digital transmission interface converter is configured to convert a first audio packet into multiple audio samples. The buffer circuit is coupled to the digital transmission interface converter and is configured to store the audio samples according to a first clock and to output the audio samples according to a second clock. The frame encoder is coupled to the buffer circuit and is configured to encode the audio samples to generate a second audio packet. The ARC analog transmitting end is coupled to the buffer circuit and the frame encoder and is configured to generate the second clock and to generate the audio signal based on the second clock and the second audio packet. The clock adjustment circuit is coupled to the buffer circuit and the ARC analog transmitting end and is configured to adjust the second clock according to a rate of increase of the number of the audio samples in the buffer circuit.

The technical means embodied in the embodiments of the present invention can solve at least one of the problems of the prior art. Therefore, compared to the prior art, the present invention has higher compatibility.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is the schematic diagram of reconstructing an audio clock according to the prior art.

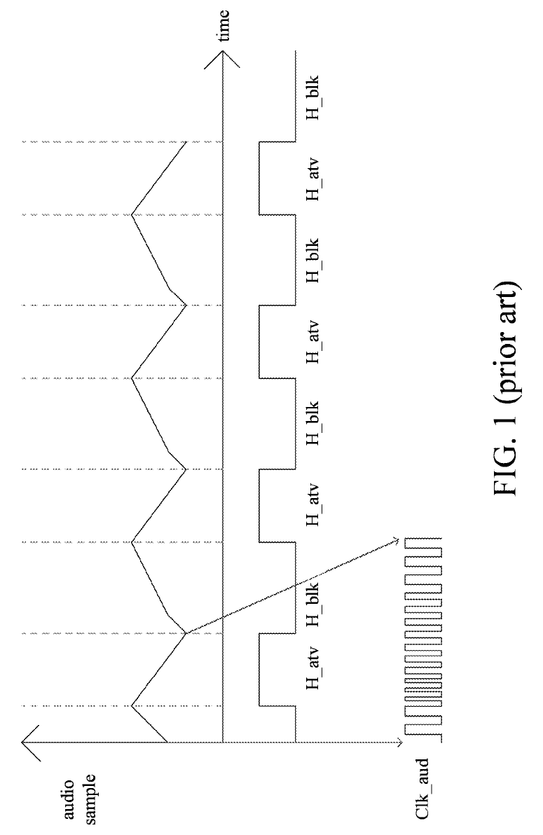

FIG. 2 is the functional block diagram of an ARC transmitter according to an embodiment of the present invention.

FIG. 3 is the functional block diagram of a clock tracking circuit according to an embodiment of the present invention.

FIG. 4 is the functional block diagram of an ARC transmitter according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an Audio Return Channel (ARC) transmitter of the High-Definition Multimedia Interface (HDMI). On account of that some or all elements of the ARC transmitter could be known, the detail of such elements is omitted provided that such detail has little to do with the features of this disclosure, and that this omission nowhere dissatisfies the specification and enablement requirements. A person having ordinary skill in the art can choose components or steps equivalent to those described in this specification to carry out the present invention, which means that the scope of this invention is not limited to the embodiments in the specification.

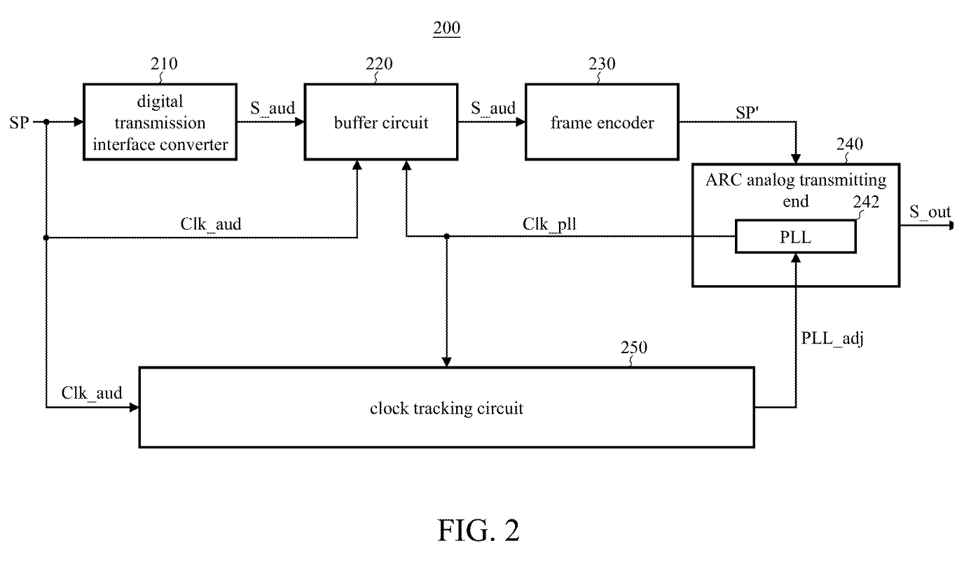

Reference is made to FIG. 2, which is the functional block diagram of an ARC transmitter according to an embodiment of the present invention. The ARC transmitter 200 includes a digital transmission interface converter 210, a buffer circuit 220, a frame encoder 230, an ARC analog transmitting end 240, and a clock tracking circuit 250, all of which are coupled to one another. In some embodiments, the digital transmission interface converter 210 is a Sony/Philips Digital Interface Format (S/PDIF) converter. S/PDIF is a digital transmission interface jointly formulated by SONY and PHILIPS companies, which can be used to transmit audio signals.

The digital transmission interface converter 210 is used to convert the audio packet SP into the audio sample S_aud and write the audio sample S_aud into the buffer circuit 220 according to the audio clock Clk_aud. The audio packet SP is a packet that complies with the IEC60958-1 specification and contains the audio clock Clk_aud. People having ordinary skill in the art are well aware of the IEC60958-1 specification and can implement the digital transmission interface converter 210 based on the specification, so the details of the digital transmission interface converter 210 are omitted for brevity.

The buffer circuit 220 may be an asynchronous first-in first-out (FIFO) buffer circuit, configured to store the audio sample S_aud. The digital transmission interface converter 210 writes the audio sample S_aud into the buffer circuit 220 according to the audio clock Clk_aud, and the frame encoder 230 reads the audio sample S_aud from the buffer circuit 220 according to the target clock Clk_pll. In other words, the buffer circuit 220 stores the audio sample S_aud according to the audio clock Clk_aud, and outputs the audio sample S_aud according to the target clock Clk_pll. The depth of the buffer circuit 220 only needs to be sufficient to handle the transient frequency deviation between the audio clock Clk_aud and the target clock Clk_pll. In some embodiments, the depth of the buffer circuit 220 is 64 stages.

The frame encoder 230 is an encoder that complies with the IEC60958-1 specification and is configured to encode the audio sample S_aud based on the IEC60958-1 specification to generate the audio packet SP'. People having ordinary skill in the art are well aware of the IEC60958-1 specification and can implement the frame encoder 230 based on that specification; therefore, the details of the frame encoder 230 are omitted for brevity.

The ARC analog transmitting end 240 includes a phase-locked loop (PLL) 242. The PLL 242 generates the target clock Clk_pll. The ARC analog transmitting end 240 converts the audio packet SP' into the analog audio signal S_out according to the target clock Clk_pll. Converting the audio packet SP' into the audio signal S_out based on the IEC60958-1 specification is well known to people having ordinary skill in the art, so further elaboration is omitted for brevity. Note that the ARC analog transmitting end 240 performs the conversion based on the target clock Clk_pll, rather than based on the audio clock Clk_aud of the audio packet SP.

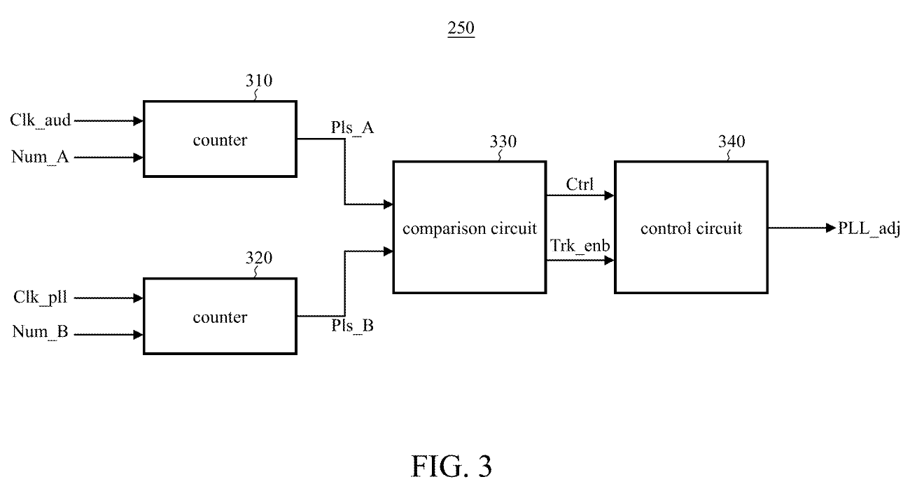

The clock tracking circuit 250 is coupled to the ARC analog transmitting end 240 and is configured to generate, according to the audio clock Clk_aud and the target clock Clk_pll, the adjustment signal PLL_adj used to adjust the target clock Clk_pll. The clock tracking circuit 250 aims to make the frequency of the target clock Clk_pll vary with the frequency of the audio clock Clk_aud, while maintaining smaller jitter. The implementation details of the clock tracking circuit 250 will be detailed below in connection with FIG. 3.

Reference is made to FIG. 3, which is the functional block diagram of a clock tracking circuit according to an embodiment of the present invention. The clock tracking circuit 250 includes a counter 310, a counter 320, a comparison circuit 330, and a control circuit 340, all of which are coupled to one another.

The counter 310 counts based on the audio clock Clk_aud. Upon detecting a rising edge (or falling edge) of the audio clock Clk_aud, the counter 310 increments the count value by 1. When the count value equals the value Num_A, the counter 310 generates a pulse signal Pls_A.

The counter 320 counts based on the target clock Clk_pll. Upon detecting a rising edge (or falling edge) of the target clock Clk_pll, the counter 320 increments the count value by 1. When the count value equals the value Num_B, the counter 320 generates a pulse signal Pls_B.

For a regular ARC, the value Num_A is equal to the value Num_B.

For the eARC, the value Num_A and the value Num_B are related to the number of input channels and the number of output channels. Assume that the eARC contains N input channels and M output channels (where N and M are positive integers). When the input of the eARC is parallel in audio, the ratio of Num_B to Num_A equals M/2. When the input of the eARC is serial in audio, the ratio of Num_B to Num_A equals M/N. When the layout type of IEC60958-1 is the Compressed B type, the ratio of Num_B to Num_A equals 4. In other embodiments, the value Num_A and the value Num_B can be determined based on the input throughput and the output throughput of the eARC.

The comparison circuit 330 generates a control signal Ctrl and an enable signal Trk_enb based on the pulse signal Pls_A and the pulse signal Pls_B. The enable signal Trk_enb indicates whether the frequency of the target clock Clk_pll needs to be adjusted (equivalent to indicating whether the PLL 242 needs to be adjusted), and the control signal Ctrl indicates whether to increase or decrease the frequency. For example, (1) when the pulse signal Pls_A and the pulse signal Pls_B are generated at substantially the same time (indicating that the frequency of the audio clock Clk_aud is substantially the same as the frequency of the target clock Clk_pll), the enable signal Trk_enb indicates that the frequency of the target clock Clk_pll does not need to be adjusted; (2) when the pulse signal Pls_A is generated earlier than the pulse signal Pls_B (indicating that the frequency of the audio clock Clk_aud is higher), the enable signal Trk_enb indicates that the frequency of the target clock Clk_pll needs to be adjusted, and the control signal Ctrl indicates that the frequency of the target clock Clk_pll should be increased; or (3) when the pulse signal Pls_A is generated later than the pulse signal Pls_B (indicating that the frequency of the target clock Clk_pll is higher), the enable signal Trk_enb indicates that the PLL 242 needs to be adjusted, and the control signal Ctrl indicates that the frequency of the target clock Clk_pll should be decreased.

The control circuit 340 generates the adjustment signal PLL_adj according to the control signal Ctrl and the enable signal Trk_enb. In some embodiments, the PLL 242 is a fractional-N PLL, and the adjustment signal PLL_adj is a signal used to adjust the divisor of the PLL 242, or a signal that directly represents the divisor. In other words, the PLL 242 generates the target clock Clk_pll according to the divisor. When the control signal Ctrl indicates that the frequency of the target clock Clk_pll should be increased, the control circuit 340 increases the divisor. When the control signal Ctrl indicates that the frequency of the target clock Clk_pll should be decreased, the control circuit 340 decreases the divisor. When the enable signal Trk_enb indicates that the PLL 242 does not need to be adjusted, the control circuit 340 does not adjust the divisor.

When the value Num_A and the value Num_B become smaller, the PLL 242 is adjusted more frequently. When the value Num_A and the value Num_B become larger, the PLL 242 is adjusted less frequently.

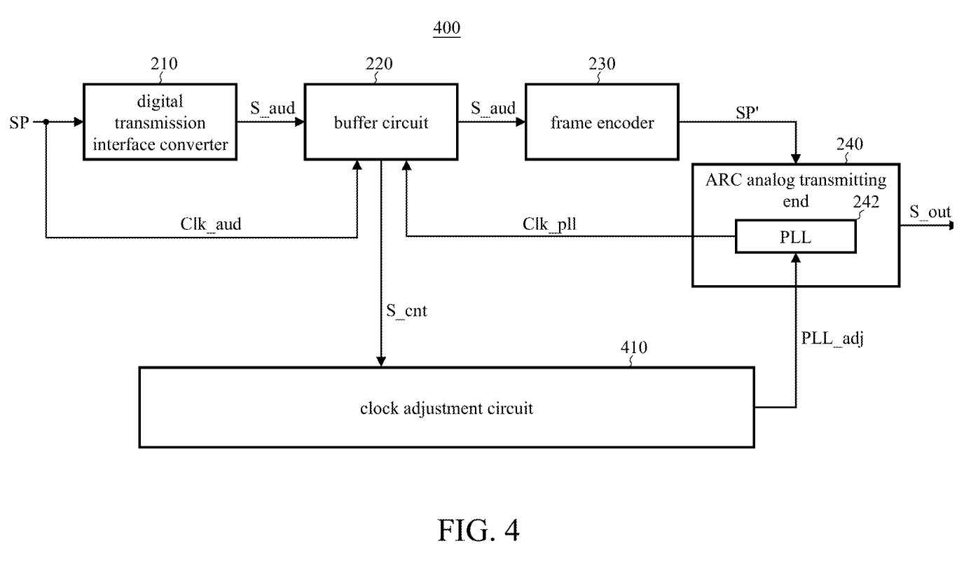

Reference is made to FIG. 4, which is the functional block diagram of an ARC transmitter according to another embodiment of the present invention. The ARC transmitter 400 includes the digital transmission interface converter 210, the buffer circuit 220, the frame encoder 230, the ARC analog transmitting end 240, and a clock adjustment circuit 410. The clock adjustment circuit 410 generates the adjustment signal PLL_adj according to the audio sample count S_cnt (i.e., the number of audio samples S_aud) in the buffer circuit 220. More specifically, when the clock adjustment circuit 410 detects that the rate of increase in the audio sample count S_cnt becomes faster (indicating that the frequency of the audio clock Clk_aud is greater than the frequency of the target clock Clk_pll), the clock adjustment circuit 410 increases the divisor of the PLL 242. When the clock adjustment circuit 410 detects that the rate of increase in the audio sample count S_cnt becomes slower (indicating that the frequency of the audio clock Clk_aud is lower than the frequency of the target clock Clk_pll), the clock adjustment circuit 410 decreases the divisor of the PLL 242. As previously stated, the clock adjustment circuit 410 can adjust the target clock Clk_pll by adjusting the divisor. Other functional blocks in the ARC transmitter 400 operate similarly to the corresponding functional blocks in the ARC transmitter 200, so further elaboration is omitted for brevity.

The clock adjustment circuit 410 can check the rate of increase in the audio sample count S_cnt at every preset time interval. The smaller the preset time interval, the more frequently the PLL 242 is adjusted. The larger the preset time interval, the less frequently the PLL 242 is adjusted.

In summary, the present invention generates the corrected target clock Clk_pll based on an audio clock Clk_aud, and then generates the audio signal S_out based on the target clock Clk_pll. Because the frequency of the target clock Clk_pll is equivalent to the average frequency of the audio clock Clk_aud over a period of time (which is related to the value Num_A and/or the value Num_B, or to the preset time interval), the jitter of the target clock Clk_pll is therefore relatively small. In the actual circuit, the jitter of the target clock Clk_pll is only about 65% or less of that of the audio clock Clk_aud. Therefore, compared to the prior art, the ARC transmitter of the present invention has higher compatibility.

Various functional components or blocks have been described herein. As appreciated by persons skilled in the art, in some embodiments, the functional blocks can preferably be implemented through circuits (either dedicated circuits, or general purpose circuits, which operate under the control of one or more processors and coded instructions), which typically comprise transistors or other circuit elements that are configured in such a way as to control the operation of the circuitry in accordance with the functions and operations described herein. As further appreciated by persons skilled in the art, the specific structure or interconnections of the circuit elements can typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

Note that the shape, size, and ratio of any element in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An Audio Return Channel (ARC) transmitter of a High-Definition Multimedia Interface (HDMI), the ARC transmitter being configured to output an audio signal and comprising:
a digital transmission interface converter configured to convert a first audio packet into a plurality of audio samples;
a buffer circuit coupled to the digital transmission interface converter and configured to store the plurality of audio samples according to a first clock, and output the plurality of audio samples according to a second clock;
a frame encoder coupled to the buffer circuit and configured to encode the plurality of audio samples to generate a second audio packet;
an ARC analog transmitting end coupled to the buffer circuit and the frame encoder, and configured to generate the second clock and to generate the audio signal according to the second clock and the second audio packet; and
a clock tracking circuit coupled to the digital transmission interface converter and the ARC analog transmitting end and configured to adjust the second clock according to the first clock and the second clock.

2. The ARC transmitter of claim 1, wherein the ARC analog transmitting end comprises:
a fractional-N phase-locked loop (PLL) configured to generate the second clock according to a divisor.

3. The ARC transmitter of claim 2, wherein the clock tracking circuit comprises:
a first counter configured to generate a first count value according to the first clock, wherein when the first count value equals a first value, the first counter generates a first signal;
a second counter configured to generate a second count value according to the second clock, wherein when the second count value equals a second value, the second counter generates a second signal;
a comparison circuit coupled to the first counter and the second counter and configured to generate a control signal according to the first signal and the second signal; and
a control circuit coupled to the comparison circuit and configured to generate an adjustment signal according to the control signal;
wherein the adjustment signal is the divisor or is used to adjust the divisor.

4. The ARC transmitter of claim 3, wherein when the first signal is generated earlier than the second signal, the control circuit increases the divisor.

5. The ARC transmitter of claim 3, wherein when the first signal is generated later than the second signal, the control circuit decreases the divisor.

6. The ARC transmitter of claim 3, wherein the first value is equal to the second value.

7. The ARC transmitter of claim 3, wherein the ARC transmitter is an enhanced ARC transmitter and contains N input channels and M output channels; N and M are both positive integers; and a ratio of the second value to the first value is one of M/2, M/N, and 4.

8. The ARC transmitter of claim 1, wherein the buffer circuit is an asynchronous first-in first-out buffer circuit.

9. The ARC transmitter of claim 1, wherein the digital transmission interface converter is a Sony/Philips Digital Interface Format (S/PDIF) converter; the audio signal conforms to the IEC60958-1 specification; and the first clock is included in the first audio packet.

10. An Audio Return Channel (ARC) transmitter of a High-Definition Multimedia Interface (HDMI), the ARC transmitter being configured to output an audio signal and comprising:
a digital transmission interface converter configured to convert a first audio packet into a plurality of audio samples;
a buffer circuit coupled to the digital transmission interface converter and configured to store the plurality of audio samples according to a first clock, and output the plurality of audio samples according to a second clock;
a frame encoder coupled to the buffer circuit and configured to encode the plurality of audio samples to generate a second audio packet;
an ARC analog transmitting end coupled to the buffer circuit and the frame encoder, and configured to generate the second clock and to generate the audio signal according to the second clock and the second audio packet; and
a clock adjustment circuit coupled to the buffer circuit and the ARC analog transmitting end and configured to adjust the second clock according to a rate of increase of the number of the plurality of audio samples in the buffer circuit.

11. The ARC transmitter of claim 10, wherein the ARC analog transmitting end comprises:
a fractional-N phase-locked loop (PLL) configured to generate the second clock according to a divisor.

12. The ARC transmitter of claim 11, wherein the clock adjustment circuit adjusts the second clock by adjusting the divisor.

13. The ARC transmitter of claim 12, wherein when the rate of increase becomes faster, the clock adjustment circuit increases the divisor.

14. The ARC transmitter of claim 12, wherein when the rate of increase becomes slower, the clock adjustment circuit decreases the divisor.

15. The ARC transmitter of claim 10, wherein the buffer circuit is an asynchronous first-in first-out buffer circuit.

16. The ARC transmitter of claim 10, wherein the digital transmission interface converter is a Sony/Philips Digital Interface Format (S/PDIF) converter; the audio signal conforms to the IEC60958-1 specification; and the first clock is included in the first audio packet.
